(19) United States
(12) Patent Application Publication
(10) Pub. No.: US 2009/0112650 A1
(43) Pub. Date: Apr. 30, 2009

(54) ONLINE METHOD OF PROCURING MORTGAGE LOANS

(76) Inventor: Donna S. Iwane, Waipahu, HI (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/932,418

(22) Filed: Oct. 31, 2007

(51) Int. Cl. G06Q 40/00; G06Q 10/00; G06Q 30/00

(52) U.S. Cl. 705/7; 705/14; 705/35

(57) ABSTRACT

A method for prioritizing candidate wholesale loan lenders in response to a loan request by a mortgage broker for a client including establishing a lender database serving as a repository of electronic client files generated by said mortgage broker in connection with a client's loan request, permitting subscribing wholesale lenders to access to said lender database via a network, allowing the lenders access said electronic client files from said lender database according to a permission associated with each electronic client file, forwarding via said lender database responses to said mortgage broker, and assigning a hierarchy of the selected subscribing wholesale lenders' responses to said loan request.

### BACKGROUND OF THE INVENTION

The present invention relates to a loan origination software in combination with an online method for procuring loan offers from multiple wholesale lenders.

Typically, home buyers and customers in the market for a property loan utilize the services of a mortgage broker to secure a loan. These clients of the mortgage broker predominantly deal only with the broker, who in turn attempts to secure a loan from a wholesale money lender. The mortgage broker relies on the wholesale lender to quote, approve, and/or make loan recommendations for their client's loan files. The mortgage broker then reviews the lender's response and takes the appropriate course of action, be it taking steps to conclude the loan process, continue further discussions with the lender to arrive at mutually agreeable loan terms, or seek out a new lender.

Communications between the mortgage broker and the wholesale lender have traditionally taken many forms, from in person contacts to telephone to facsimile exchanges. For example, the mortgage broker could contact a wholesale lender directly to speak with an account executive, either in person or on the telephone, about obtaining a verbal quote or recommendation on a loan. The broker might then be required to transmit via mail or facsimile pertinent loan information and documents needed by the account executive to assess the potential loan. Alternatively, the broker might submit a physical loan file to the wholesale lender's office for consideration and await a response either verbally or by written communication. This system had many inherent delays for the mortgage broker, which could be exacerbated by slow response times of the wholesale lenders. This in turn led to dissatisfaction by the broker's clients and frustration with the lender's response times.

### SUMMARY OF THE INVENTION

The present invention relates to a method for facilitating an expeditious communication exchange between a mortgage broker and a wholesale lender in connection with a client's loan application file, and prioritizing candidate wholesale loan lenders based on price and response time. The mortgage broker, in seeking a loan for its client, utilizes an internet or network-based online loan origination and processing system that cooperates with a lender database to exchange documents and files. The lender database operates as a repository of electronic client files generated by the mortgage broker in connection with a client's loan request. This lender database is accessible via the internet and allows both mortgage brokers, and wholesale lenders the opportunity to access the lender database remotely using a computer, hand-held device, cell phone, or other communication device equipped with internet capabilities. Subscribing wholesale lenders access the lender database to fulfill loan transactions submitted by the mortgage broker.

In a preferred method of the present invention, the mortgage broker creates a client file comprising electronic documents such as credit reports, loan application form(s), comparable property listings, etc., and uploads the file to the lender database. The mortgage broker may assign a permission to each document in the file, thereby limiting access of those documents to those wholesale lenders or clients designated by the mortgage broker. After reviewing the file, the wholesale lender can respond to the mortgage broker, for example by accepting the terms of a proposed loan, offering suggestions for a new proposal, or offering a comment on the proposal.

The wholesale lender's response is sent to the lender database, where it is compared with other responses from other lenders. The program establishes a hierarchy of the responses, using for example the price or interest rate offered by the lender as the primary factor. A secondary factor preferably could include the time needed by the lender to respond to the mortgage broker's proposal. A listing of lender responses is sent to the mortgage broker in a report, ordered according to said hierarchy, with the lenders offering the lowest price at the top of the hierarchy and preference given in the case of equal quotes to the fastest response. The mortgage broker reviews the responses presented in said hierarchical order, and selects the lender best suited for its client. It is understood that while the hierarchical order may be influential in determining the choice of lender, the broker is free to select any lender that best meets the needs of the broker's client.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is an exemplary welcome screen of the present invention;

FIG. 2 is an exemplary screen shot of a new loan proposal page of the present invention;

FIG. 3 is an exemplary screen shot of a loan status page of the present invention;

FIG. 4 is an exemplary screen shot of a documents menu option page of the present invention;

FIG. 5 is an exemplary screen shot of a permission screen associated with a particular document of the present invention;

FIG. 6 is an exemplary screen shot of a dialog box for communication between a broker and a lender;

FIG. 7 is an exemplary screen shot of an auto-marketing page of the present invention;

FIG. 8 is a flow chart of the activities and actions that may be instituted by the mortgage broker in carrying out the process of the present invention;

FIG. 9 is a flow chart of the activities and actions that may occur in the lender database in carrying out the process of the present invention; and

FIG. 10 is a flow chart of the actions and activities that may be carried out by a wholesale lender in carrying out the process of the present invention.

### DETAILED DESCRIPTION OF THE PREFERRED EMBODIMENTS

The present invention utilizes a web-based loan origination and loan processing system and method specifically designed for use by mortgage industry professionals. The program and method utilize a website accessible to participating mortgage brokers and wholesale lenders throughout the country via a conventional web browser. The program is preferably password or “key” protected to generate revenue from, for example, monthly or yearly subscription sales. Participating mortgage brokers who purchase a key may access an entire range of program features, including complete loan preparation and processing capabilities, pre-prepared loan processing forms, protection and permission setting capabilities for its clients' files, and other tools to assist them with all aspects of originating and processing mortgage loans. Participating wholesale lenders have access to a lender database that allows the lenders to price or respond to loan proposals submitted by brokers into the database, and well as review past performance of previous bids.

The program loaded on the website allows a mortgage broker to create an electronic loan file for each of the broker's customers, and to consolidate and store all customer files in a centralized lender database, where they can be selectively made accessible to wholesale lenders nationwide. Each broker creates his own separate database of client loan files, and the databases of all subscribing brokers may preferably reside on a single data server. A mortgage broker creates each separate customer loan file by providing information to the program in response to a series of dropdowns, textboxes and pop-up windows generated by the program. From the website, the broker has the ability to access his client's loan files and check the status of the loan anytime or anywhere that internet access is available. Once a loan file is complete, an email is sent to the customer notifying the customer of the completion of the loan application, and providing a link to the web site where the customer can log in and monitor the status of his or her particular loan application. The program allows the mortgage broker flexibility to control how much information and which documents each customer can access.

The lender database is used by the mortgage broker to solicit feedback from potential wholesale lenders that will enable the broker to prepare loan proposals for his or her customers. As part of this process, the broker can select whether standardized or supplemental information about the customer's file will be made available to participating wholesale lenders. The broker also chooses whether to make the data available to all subscribing lenders or to only certain lenders of the broker's choice.

A subscribing wholesale lender may use his key or password to access the lender database from his computer's desktop or any other device with an operating web browser, and view a list of loan application files from various mortgage brokers giving that lender permission to view their clients' loan files. The lender can then view selected information and documents from the files of the broker's clients, and provide feedback to the broker online via the internet in response to each client file in the database. Responding lenders will have the ability to quote an interest rate, conditionally approve a loan proposal, suspend a loan response pending further inquiry, decline a loan proposal, or make a loan suggestion in response to the loan files they select. However, they will only be allowed to access those documents in the file that the broker specifically gives them permission to view. For example, the file may have a client credit report but the broker may not authorize all lenders to view the report. In this situation, only those lenders approved to access the client's credit report will have access. The program also allows for multiple lenders to be able to view the same broker's loan files at the same time.

The present invention allows each mortgage broker to monitor the lenders' responses to their loan files online. The broker also controls the period in which lenders have to respond, and the expiration of the period set by the broker may foreclose any further responses by the lenders. The broker can set automatic parameters on the process, such as time limits on responding, instruct the program to close the opportunity for responding once a certain number of responses or a certain interest rate is received, or the broker can terminate the process manually if they no longer need further responses from lenders. In reply to a lender's response, the broker can communicate a question or response back to the lender via the lender database using the program. Lenders preferably can change or update their responses until the mortgage broker closes the process, either automatically or manually. Once the process is closed, the broker reviews the lender responses, selects the lender and loan program of his choice for the customer, and prepares a loan proposal for the customer to review. Once the customer accepts the proposal, the loan can be processed for final approval or funding.

A novel feature of the present invention is that responding lenders are rated on how quick they respond as well as on their pricing. These lender ratings are then used to determine the order in which the responses are displayed on the broker's screen. For example, the top ten lenders with the lowest interest rate quotes could be listed first in order of price. If multiple lenders quote the same rate for the loan, they will be listed in the order of their respective response time from quickest to slowest. If the lender's response is not consistent with the mortgage broker's request, it will be excluded from the listing. One purpose of the rating system is to create competition among wholesale lenders, who will not be allowed to see the quotes of other lenders. Lenders who have previously quoted on files can download statistics on their own participation and success to assist them in improving their pricing and competitiveness. Brokers can download statistics on the performance records of lenders regarding participation, relative quote levels, and final backing of initial quotes.

In addition to receiving lender quotes, a broker also can use the system to upload his files for viewing, to complete and print standardized loan documents, to view status reports that track his loan applications through the approval process, and to create customized loan proposals for his customers from a personalized template. The program also provides for automated calendaring of daily task reminders and dates for upcoming task deadlines. Further, the program can be used as an effective marketing tool to contact clients on present loan rates and other news of interest that can generate leads and additional business opportunities for the mortgage broker.

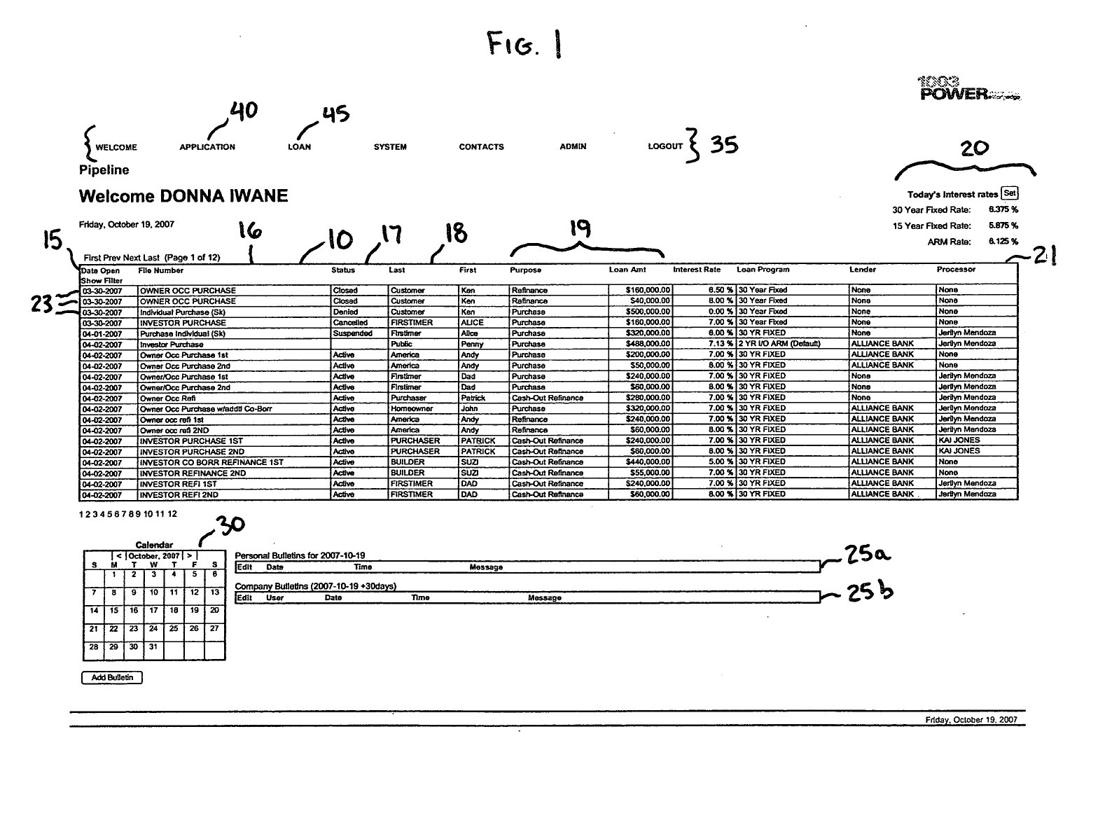

With reference to FIG. 1, the present invention is directed to a web-based program that is accessible twenty-four hours a day from anywhere using a standard web browser. FIG. 1 illustrates an exemplary welcome screen that appears after a log-in prompt. The welcome screen may act as a home page while navigating through the program. As further shown in FIG. 1, the exemplary welcome screen includes a pipeline report 10, a current interest rate 20 section, a calendar 30, and personal and company bulletins 25a, b.

The pipeline report 10 is the mortgage broker's quick status view of all pending loans. When a new loan file is created, it automatically shows up on the pipeline report 10. Also, when a loan closes, that file is deleted from the pipeline report. The status report includes a line entry for a date the file was opened 15, the type of loan file 16, the status of the loan 17, the name of the client 18, a loan amount and type 19, and the name of the processor 21. The pipeline report 10 allows the broker to quickly view all of the pending files and quickly see the status of each loan upon logging into the program. By clicking on the individual loans 23, additional information on the loans pop up that enables the broker to see the full loan application and the related documents in a quick and efficient manner.

The current interest rate 20 value is set by the broker as a convenience to avoid having to locate and refer to a quote sheet all day while processing new loan customers. The broker will typically select the best rate of the day from one of its wholesale lenders and then input the value into the Today's Rate location 20 in the upper right hand corner of the welcome screen when signing on in the morning. The mortgage broker can then continuously refer to the rate quickly without any further searching throughout the day. The current interest rate 20 can also trigger a marketing feature whereby existing customers are sent a message if the current interest rate set above is less by a predetermined threshold value from the customer's existing interest rate, as discussed more fully below.

The calendar 30 is used to keep the mortgage broker updated on appointments, tasks, deadlines, meetings, and upcoming events. Data can be entered into the calendar and accessed by using a pointer to click on the specific day. Any events or appointments of that day will appear next to the calendar 30 under bulletin, listed by date and time. Reminders and alarms can be set using the calendar feature. The personal and company bulletin 25a, 25b can be used to track all personal and company appointments, meetings, signings, deadlines, etc. Personal bulletins can be shielded from other company employees, while company bulletins are typically viewable by all company personnel with access to the program.

From the menu bar 35 of the welcome screen, the “application” drop down menu 40 allows a mortgage broker to create a new client file. The new client file is populated with the necessary information, e.g. client name, account number, personal information, loan type and amount, and contact information. Once the file is created, it appears on the pipeline report 10 as a pending loan and the system will automatically generate a user name and pass code for the borrower to access the system and view loan status, documents and a time and date stamped conversation log. Additional pull-down menus can assign a status to the new file (active, closed, pending, suspended, denied, cancelled, etc.), as well as lead type (personal or company) and category. The lead information can be used to ensure that proper commissions are fulfilled and various marketing strategies can be assessed (newspaper versus telephone listing for example). This information can be presented in a lead report that collects all of the lead data to better analyze marketing effectiveness.

A second pull down menu from the menu bar 35 is the loan menu 45, including an information sheet that consolidates all of the client's loan data onto a single sheet. The information sheet collects data used in various standard mortgage loan forms (1008, 1003), credit reports, income statements, asset statements, and other documentation. A module in the program can later transfer the data from the loan information sheet to standard loan applications for each proposal, thereby saving valuable time.

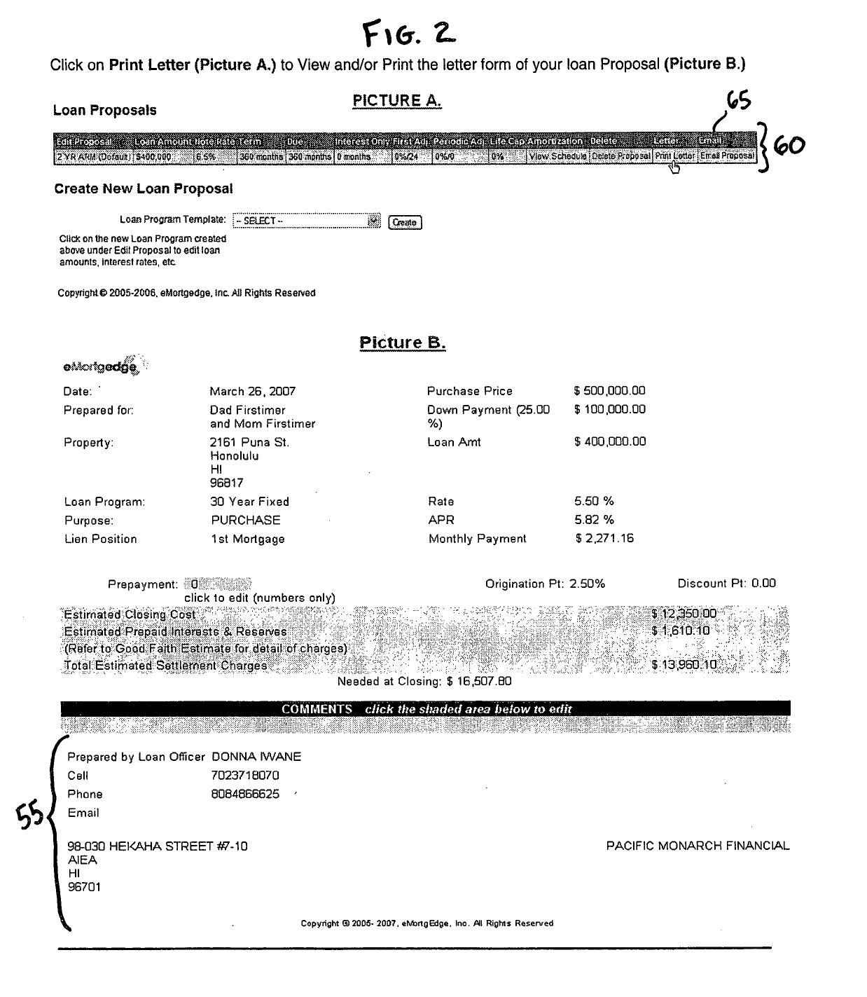

The loan pull down menu 45 also includes a proposal option that allows the broker to set up loan proposals for each loan scenario of the client. The proposal option creates various loan forms (1008, 1003, good faith estimate (GFE), and truth in lending statement (TIL)) without having to reenter the information each time. The loan program template from within the proposal menu allows the broker to select from among many standard loan types, such as “thirty year fixed,” “ten year ARM,” etc. Other loan types can be customized and entered into the menu to increase flexibility and track trends and changes in the loan industry. There is also a screen to edit loan proposals, including changing the margin, index, loan amount, personal information, and payments. This edit function can also be used to create a new loan proposal. A loan proposal, as shown in FIG. 2, reflects the basic terms for the mortgage client's loan request. There is a box 55 to enter and save comments on the page, such as any particular needs or requests of the client or any special conditions of the loan proposal. The tool bar 60 includes an e-mail menu 65 that allows the broker to e-mail selected recipients the loan proposal. In addition, the 1008 Transmittal Summary, 1003 Uniform Residential Loan Application, the Good Faith Estimate, and the Truth In Lending forms created automatically with a click of mouse using the data already provided in the client's loan proposal.

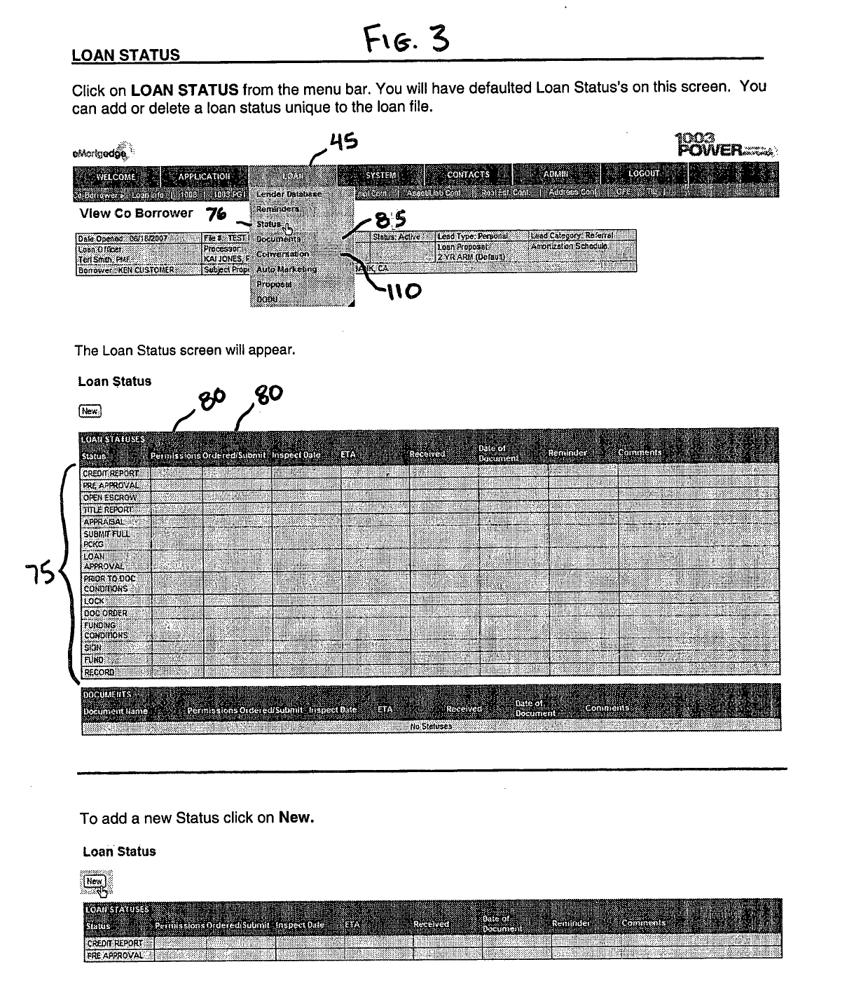

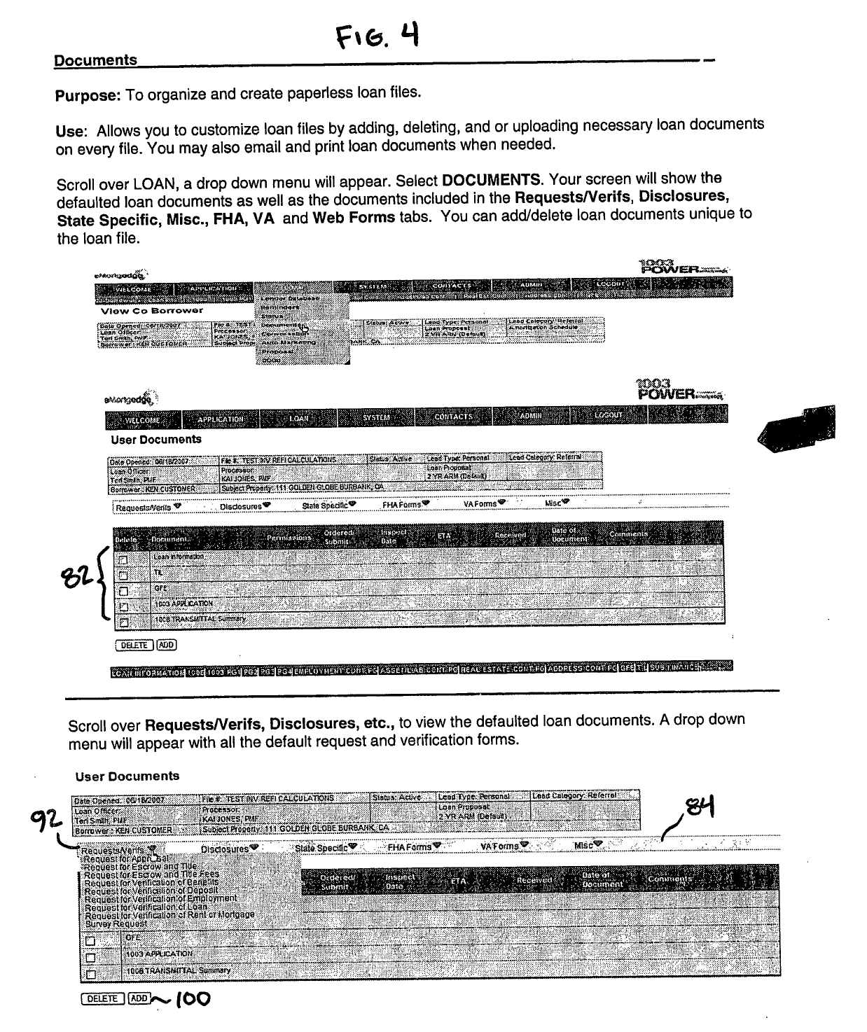

From the main menu, the loan pull-down menu 45 can be activated to view a loan status 76 as shown in FIG. 3. The loan status page shows various tasks 75 associated with a loan proposal, including credit report, pre-approval, escrow opening, title report, appraisal, loan approval, rate lock, documentation order, funding conditions, signing, funding, and recording. Each condition has several columns 80 that allow tracking and planning, including dates for requests, estimated time to complete, receipt of documents, deadlines, reminders, and comments. The loan pull down menu 45 also has a documents option 85 that allows the broker to customize loan files by adding, deleting, or amending various loan documents associated with each loan proposal or loan file. When activated the documents option, the default loan documents 82 are highlighted as well as the documents 84 included in the requests/verifications disclosures, disclosures, state specific documents, FHA forms, and miscellaneous tabs 90 (FIG. 4). The requests/verification tab 92 is a pull down menu that includes a form for a requests for: appraisal; escrow and title, escrow and title fees; verification of benefits; verification of deposit; verification of employment; verification of loan, verification of rent or mortgage; and a survey request. Other forms can be added to the list using an add tab 100. With each document, all necessary data can be entered including dates ordered, submitted, inspected, received, and so forth, as well as add comments and reminders for tracking the document.

Each document can be set so as to select a read permission for the borrower and/or the lender. As shown in FIG. 5, the broker checks a box 105 that allows either the borrower or the lender to read the document. If unchecked, neither the borrower nor the lender will have access to the particular document. In this way, the broker can manage the data and ensure that information is limited to only those individuals that the broker feels needs the information. Once completed, an “add” button 106 is clicked to add the document to the customer file.

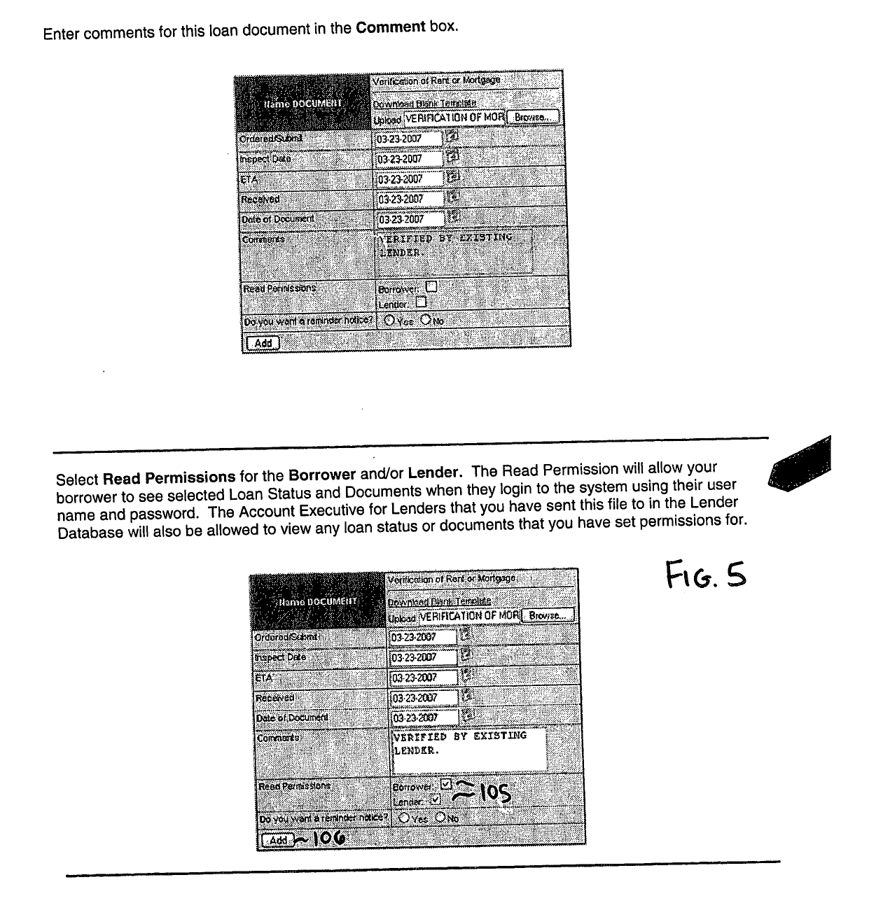

The loan pull down menu 45 further includes a conversation option 110 for activating a communication log between the broker, the borrower, and the lender. Each entry in the log is date and time stamped 115 to ensure proper tracking. As shown in FIG. 6, new comments are entered in a new comment box 120, where the broker types in a message or request for the borrower or lender. Each comment has a read permission 130 to control who has access to the comments, activated by the broker. The new comment box 120 also includes reminders 135 to follow-up or provide a deadline for responding to the communication.

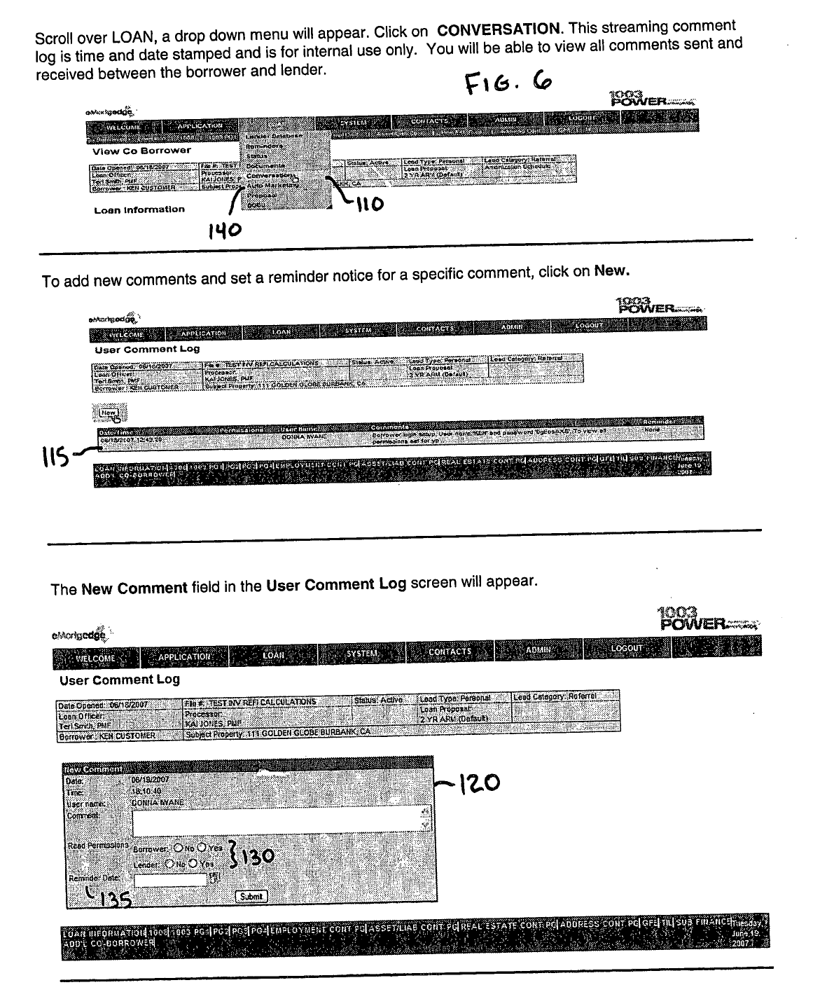

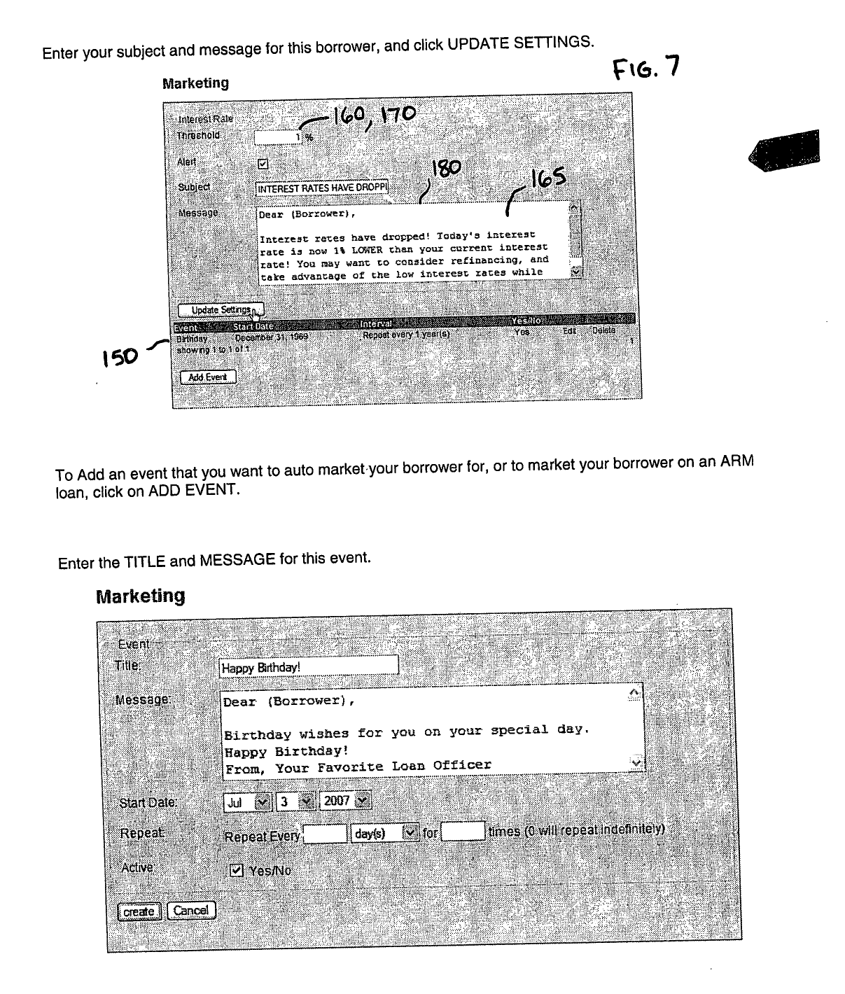

The loan pull down menu 45 also includes an auto-marketing option 140 that allows the broker to promote his or her services and generate new business. The auto-marketing sends an e-mail or other communication to the borrower in the event of a specified condition. For example, the mortgage broker could enter the borrower's birth date 150 and have the program send an e-mail on the borrower's birthday every year wishing the borrower a happy birthday. Alternatively, the broker could enter an interest rate of the borrower and set the program to send an e-mail message to the borrower if the current interest rate is more than a predetermined threshold 160 below the client's interest rate, and invite the borrower to contact the broker about refinance options 165. In this case, a threshold value is set in the marketing box 170 (FIG. 7) and a message is entered in the text box 180 inviting the customer to call the broker about new lower rates.

When a file is complete, the broker can then submit the borrower's loan file to subscribing lenders through the lender database. Subscribing lenders can price, approve, and/or make suggestions to loan files and send them back to the broker through the lender database. From the loan pull down menu, the lender database option is selected. The broker will have the option of selecting any lender by name within the database, or select all lenders to permit all subscribing wholesale lenders in the lender database to view the file. The broker can enter comments and include any documents as part of the file. Once the files are checked, the broker clicks on the “submit” button that causes the file to be uploaded to the lender database. A message is automatically sent by the program to the broker informing the broker that the file was successfully uploaded to the lender database. The broker can review the loan file and its documents from the lender database at any time, as also review which lenders have been given access to the loan file.

Upon receiving a response from the lender (such as, for example, a present loan rate and a request for further information), the broker can click on the view new responses button and review the lender's response. The broker can edit any of the loan information and resend it to the same lender, or the edited file can be resent to the lender database for viewing by all lenders with permission to access the file. Additional comments can be entered via the communications log, and the dialog between the lender and borrow can continue in the manner indefinitely.

FIG. 8 is a flow chart of typical steps carried out by the mortgage broker. The flow chart reflects the possible actions of the broker beginning with step 200 where the broker logs into the website using the key or password and enters information for a new client. The information is entered in an information sheet and stored for future use. In step 205, the broker uploads all the necessary loan documentation that accompanies a loan application, including for example the standard loan application forms such as the 1008 and 1003, the good faith estimate and truth in lending statement, and any other documentation that is pertinent to the loan evaluation. Such documents can include credit reports, property comparisons, collateral statements, and the like. The documents and applications are then assigned a permission in step 210 that governs who may view the individual documents. The broker may allow all lenders to view the file, or permit only selected lenders access. In step 215, the various documents and loan applications are consolidated in a loan file, and the broker then selects which lenders will have access to the loan file from the lender database in step 220. The loan file is submitted to the lender database in step 225 for review by the selected lenders, and awaits responses from the lenders on the loan file. In step 230, the broker receives a report on the top twenty lender responses, with the report having the lenders with the lowest interest rate at the top of the list and the highest interest rate at the bottom of the list. In the case of equal interest rates, the lender with the shortest response time is given the higher position. In step 235, the broker prepares a loan proposal for the client based on the selected lender best suited for the particular client.

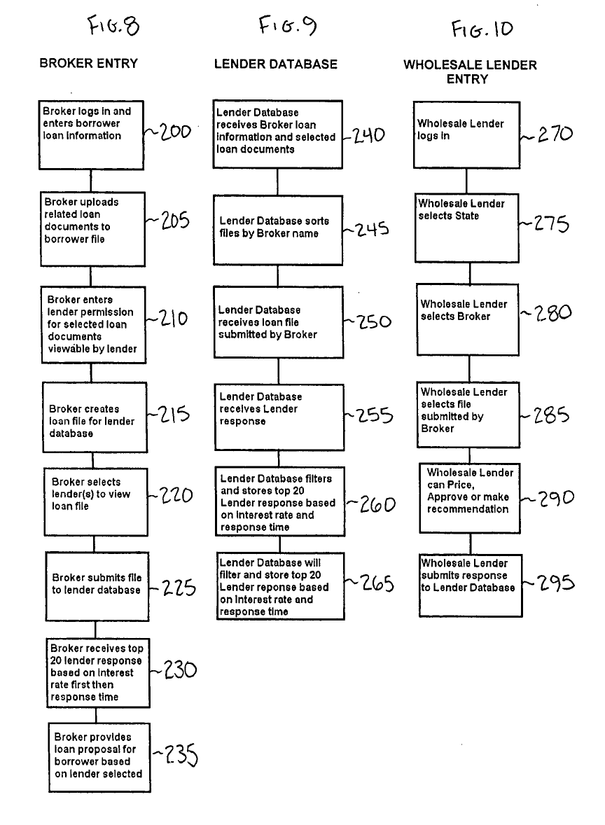

Typical activities in the lender database are reflected in the flow chart of FIG. 9, where step 240 represents the receipt of the loan documents and applications in the lender database from the mortgage broker. The lender database then sorts the received documents by broker in step 245, and the broker establishes a loan file comprising selected documents in step 250. The lenders may then access the loan file from the database, and a response is submitted back to the lender database in step 255. A filter in the program stores the first twenty responses in a hierarchy based on the best interest rate offered, with the quickest response time assigned the favored position in the case of equal rates in step 260. The mortgage broker then accesses the stored lender responses in step 265 in the order established by the filter for review and assistance in selected a possible lender.

FIG. 10 is a flow chart that reflects the typical actions of the wholesale lender, who logs into the website in step 270 and selects a state in step 275. From a list of brokers within that selected state, the lender selects a broker in step 280 and then selects a loan file from among the broker's accessible files on the lender database in step 285. The lender reviews, evaluates, and responds to the loan file in step 290 by approving, rejecting, commenting, or taking other actions in connection with the terms of the loan. The response is then submitted to the lender database in step 295 for retrieval by the mortgage broker, and the process is repeated for additional files and other clients.

A novel feature of the present invention is the ability to generate a lender report that allows the mortgage broker to view all lenders responses that the loan file was sent to. The program creates a hierarchy of lender responses that is preferably based on the best interest rate for the specified loan. The report then generates a list of lender responses, with the lowest interest rate appearing at the top of the list and the highest interest rate appearing at the bottom of the list. Where two or more interest rates are equal, the lender providing the fastest response time is placed above the others with equal interest rates. In this manner, competition is fostered between competing lenders to provide the lowest interest rate, and also to respond in an expeditious manner to the mortgage broker's loan proposal. Although the broker is free to select any lender from the report, the hierarchy provides an advantage to those lenders at the top of the list in that they are in the most favorable position to catch the broker's attention and secure the business.

Another novel feature of the present invention is the ability to assign different security levels for each broker/user by using a drop down menu. Security Level 1 can be used for administrators and key personnel, where security level 1 permits the user to edit, change, and delete loan information on closed files. The administrator can also add, edit, delete, and transfer license keys to other users within the lender's business and edit certain information contained on the lender's database about the lender. Security level 2 allows the user to view, edit, and/or change loan information on closed files. Level 2, which is typical of a manager level position, also allows the user to access all saved files within the company. Level 3 security may be assigned to other individuals in the broker's business, and allows the user to read the files but make no further changes to files that are set at “close” status. Further, only those files assigned to that particular user can be viewed by level 3 personnel, while levels 1 and 2 can view all files within the company.

Yet another novel feature of the present invention is the ability to generate reports to evaluate past performances of the lenders. For example, a mortgage broker can quickly generate a report of those lenders that have previously responded to a loan proposal and the results of their responses. Those lenders with poor performances can be removed from the permission list, while higher performing lenders can be increased in frequency. Lenders can track their own performance as well to evaluate their current operation and prospects for improved performance.

Yet another feature of the present invention is the ability of the wholesale lender to use the program to track leads for new or repeat business, attribute those leads to a sales representative or other employee, and determine a commission based on the leads. The leads are usually generated by the loan officer and/or processor, and commission rates can be input into the program for different types of products. The Broker's administrator enters the program and, using the ADMIN tab, clicks on the company to set base and commission structures for each type of lead generated by the loan officer and/or loan processor. The administrator enters information on different types of leads (personal or company), lead categories (call in, newspaper, flyer, etc.), employee position (loan officer, loan processor, etc.), fee type (origination, rebate), and a base fee generally charged for the service. The administrator also assigns a commission percentage, ranging for example from 40% to 80%, for the service. The program then tracks the commissions for each employee automatically, and can be used to prepare a report at regular intervals for payroll purposes. This auto-commission feature reduces the amount of time necessary to track and allocate commissions to the broker's various loan officers and processors, further enticing the wholesale lender to subscribe to the database and program's services.

The features of the present invention described above are intended to be illustrative of the present invention but not limiting. Rather, the concepts described herein are intended to provide context to the appended claims without limiting their scope to the described embodiments. Accordingly, the claims should be construed in view of the aforementioned described embodiments, but the meanings of the words in the claims are intended to be those conveyed by their ordinary and customary usage.

I claim:

1. A method for prioritizing candidate wholesale loan lenders in response to a loan request by a mortgage broker for a client, comprising the steps of:
establishing a lender database comprising a repository of electronic client files generated by said mortgage broker in connection with a client's loan request, said lender database remotely accessible via a network;
permitting subscribing wholesale lenders access to said lender database via said network;
allowing the selected subscribing wholesale lenders to access said electronic client files from said lender database according to a permission associated with each electronic client file, said permission set by said mortgage broker;
forwarding via said lender database responses from the selected subscribing wholesale lenders to said mortgage broker in connection with said client's loan request after accessing said electronic client files;
assigning a hierarchy of the selected subscribing wholesale lenders' responses to said loan request, said hierarchy based on preselected criteria; and
ordering said responses based on said hierarchy, and delivering said responses via said network from said lender database to said mortgage broker reflecting said ordering, for consideration by said mortgage broker.

2. The method of claim 1 wherein said hierarchy incorporates a comparison of response times of the selected subscribing wholesale lender to said loan request.

3. The method of claim 1 wherein said hierarchy incorporates a comparison of interest rates offered by the selected subscribing wholesale lenders.

4. The method of claim 1 wherein said hierarchy primarily accounts for a comparison of interest rates and secondarily accounts for a response time of said selected subscribing wholesale lender to said loan request.

5. The method of claim 1, further comprising establishing a time-stamped two way written communication mode via said network between said mortgage broker and a selected subscribing wholesale lender.

6. The method of claim 1 further comprising communicating a current loan rate from said wholesale lenders to said mortgage broker via said lender database.

7. The method of claim 1, where said electronic client files are generated from templates available via said network.

8. The method of claim 1, where said electronic client file includes a credit report, a loan application, and comparable property listings.

9. The method of claim 1, wherein said responses comprise a selected one of an approval of said loan request, a recommendation pertaining to said loan request, and a comment in connection with said loan request.

10. The method of claim 1 further comprising generating a report by said mortgage broker of all the selected subscribing wholesale lenders assigned access to an electronic client file.

11. The method of claim 1 further comprising auto-marketing whereby clients with a interest rate above a present interest rate by a pre-selected value are automatically notified of the present interest rate.

12. The method of claim 1, further comprising establishing a time-stamped two way written communication mode via said network between said mortgage broker and the client.

13. The method of claim 1 further comprising allowing said client to access said electronic client files according to a permission associated with each electronic client file, said permission set by said mortgage broker.

14. The method of claim 1 further comprising establishing a plurality of security levels associated with each permission, where said security levels relate to control over said electronic client files.

15. The method of claim 1 wherein a plurality of mortgage brokers each maintain a lender database, and wherein a plurality of lender databases exists on a common data server.

16. The method of claim 1 further comprising issuing a message to said client from said mortgage broker once an electronic client file is complete, said message including a link to a status site where said client can review a status of the loan request via said network.

17. The method of claim 1, wherein multiple wholesale lenders can access a single electronic client file from said lender database at one time.

18. The method of claim 1 further comprising generating statistics for a wholesale lender's previous performance for access by said mortgage broker and said wholesale lender.

19. The method of claim 1 further comprising compiling a list by said selected subscribing wholesale lenders of all electronic client files for which a response has been provided.

20. The method of claim 1 wherein the lender database is associated with a loan origination software package.

21. The method of claim 1, further comprising automatically tracking commissions of generated by leads and generating a report reflecting earned commissions based on said tracking.

22. A method for comparing and selecting, by a mortgage broker, candidate wholesale loan lenders for fulfilling a client's loan request, comprising the steps of:
creating an electronic client file comprising at least one document for evaluating the client's loan request, and assigning a permission associated with each of said documents by said mortgage broker;
forwarding said electronic client file to a lender database, where subscribing wholesale lenders can access said electronic client file for evaluating said client's loan request if said assigned permission allows said access;
retrieving responses from said subscribing wholesale lenders to said client's loan request, where said responses are ordered according to a predetermined hierarchy, said hierarchy reflecting a current interest rate and a response time to said client's loan request; and
selecting a wholesale lender based on said responses, where said selecting is not mandated by said hierarchy.

23. The method of claim 22, wherein said creating an electronic file is accomplished by filling in data to a template retrieved from said network.

24. The method of claim 22 including resending a revised version of said electronic client file in reply to a response by said subscribing wholesale lender.

25. The method of claim 22, further comprising automatically tracking commissions of generated by leads and generating a report reflecting earned commissions based on said tracking.

26. A method for comparing and selecting, by a mortgage broker, candidate wholesale loan lenders for fulfilling a client's loan request, comprising the steps of:
creating an electronic client file comprising at least one document for evaluating the client's loan request, and assigning a permission associated with each of said documents by said mortgage broker;
entering an auto-marketing trigger into the client's file, wherein said client is automatically contacted by said mortgage broker via a network when said auto-marketing trigger is activated;
forwarding said electronic client file to a lender database, where subscribing wholesale lenders can access said electronic client file for evaluating said client's loan request if said assigned permission allows said access;
retrieving responses from said subscribing wholesale lenders to said client's loan request, where said responses are ordered according to a predetermined hierarchy; and
selecting a wholesale lender based on said responses, where said selecting is not mandated by said hierarchy.

27. A method for prioritizing candidate wholesale loan lenders in response to a loan request by a mortgage broker for a client, comprising the steps of:
establishing a lender database comprising a repository of electronic client files generated by said mortgage broker in connection with a client's loan request, said lender database remotely accessible via a network;
permitting subscribing wholesale lenders access to said lender database via said network;
establishing a time-stamped two way written communication mode via said network between said mortgage broker and a selected subscribing wholesale lender;
allowing the selected subscribing wholesale lenders to access said electronic client files from said lender database according to a permission associated with each electronic client file, said permission set by said mortgage broker;
forwarding via said lender database responses from the selected subscribing wholesale lenders to said mortgage broker in connection with said client's loan request after accessing said electronic client files, wherein said responses comprise a selected one of an approval of said loan request, a recommendation pertaining to said loan request, and a comment in connection with said loan request.
